(19) United States
(12) Patent Application Publication
(10) Pub. No.: US 2011/0128743 A1
(43) Pub. Date: Jun. 2, 2011

(54) METHOD FOR PRODUCING LIQUID CRYSTALLINE POLYESTER, LIQUID CRYSTALLINE POLYESTER COMPOSITION, REFLECTOR PLATE AND LIGHT-EMITTING DEVICE

(75) Inventors: Yasuo MATSUMI, Tsukuba-shi (JP); Takayuki OTSUKA, Niihama-shi (JP); Shintaro SAITO, Tsukuba-shi (JP)

(73) Assignee: SUMITOMO CHEMICAL COMPANY, LIMITED, Tokyo (JP)

(21) Appl. No.: 12/955,274

(22) Filed: Nov. 29, 2010

(30) Foreign Application Priority Data
Nov. 30, 2009 (JP) 2009-271590

(51) Int. Cl. F21V 7/00; C09K 19/06

(52) U.S. Cl. 362/296.01; 252/299.6

(57) ABSTRACT

The present invention provides a method for producing a liquid crystalline polyester, the method comprising the steps of reacting monomers to obtain a polycondensate corresponding thereto, granulating the polycondensate to obtain a granule, and subjecting the granule to solid-phase polymerization to obtain a liquid crystalline polyester, wherein the content of iron in the granule to be subjected to the step (C) is 5 ppm by weight or less. According to the present invention, a liquid crystalline polyester having high whiteness and excellent heat resistance can be produced with satisfactory operability.

### BACKGROUND OF THE INVENTION

1. Field of the Invention

The present invention relates to a method for producing a liquid crystalline polyester. The present invention also relates to a liquid crystalline polyester composition using a liquid crystalline polyester produced by the method, a reflector plate using the liquid crystalline polyester composition, and a light-emitting device using the reflector plate.

2. Description of the Related Art

A reflector plate used in a light-emitting diode (LED) light-emitting device is often made of a resin from the viewpoint of processability and lightweight properties. In the production of such an LED light-emitting device, the reflector plate is sometimes subjected to a high-temperature environment during the mounting step of an LED device, the curing step of a sealing resin and the soldering step upon LED module assembling. Therefore, excellent heat resistance is required to a resin material constituting the reflector plate. Since excellent moldability is required in the production of the reflector plate, a liquid crystal polymer having excellent heat resistance and moldability, particularly a liquid crystalline polyester, has widely been studied as the resin material.

Since a high reflectance is required to the reflector plate, high whiteness (lightness) is required to the liquid crystalline polyester used as the material and a method for producing a liquid crystalline polyester having high whiteness has been studied. For example, JP-A-2003-171450 discloses that monomers are polycondensed after acylation using a reaction tank made of a heat resistant material substantially containing no iron thereby suppressing elution of iron which can cause coloration of a liquid crystalline polyester, thus making it possible to produce a liquid crystalline polyester having high whiteness.

### SUMMARY OF THE INVENTION

In the method disclosed in JP-A-2003-171450, a polycondensation temperature is raised so as to increase a molecular weight of a liquid crystalline polyester until the liquid crystalline polyester exhibits desired heat resistance. Therefore, the liquid crystalline polyester in the polycondensation tank may undergo an increase in melt viscosity due to an increase in molecular weight, thus causing a problem of operability such that it becomes difficult to extract or collect the liquid crystalline polyester from the polycondensation tank, and is likely to mix into another rot as a result of retention. There also arises a problem that the liquid crystalline polyester is likely to undergo coloration due to an increase in the polycondensation temperature. Thus, an objective of the present invention is to provide a method capable of producing a liquid crystalline polyester having high whiteness and excellent heat resistance with satisfactory operability.

In order to attain the above objective, the present invention provides a method for producing a liquid crystalline polyester, the method including the steps of:
(A) reacting monomers to obtain a polycondensate corresponding thereto,
(B) granulating the polycondensate to obtain a granule, and
(C) subjecting the granule to solid-phase polymerization to obtain a liquid crystalline polyester, wherein the content of iron in the granule to be subjected to the step (C) is 5 ppm by weight or less.

According to the present invention, there are also provided a liquid crystalline polyester composition containing a liquid crystalline polyester obtained by the above production method and a titanium oxide filler; a reflector plate produced by molding the liquid crystalline polyester composition; and a light-emitting device including the reflector plate and a light-emitting element.

According to the present invention, a liquid crystalline polyester having high whiteness and excellent heat resistance can be produced with satisfactory operability. By molding a liquid crystalline polyester composition containing the liquid crystalline polyester thus obtained and a titanium oxide filler, it is possible to obtain a reflector plate which has a high reflectance, and also has excellent heat resistance capable of enduring a high-temperature environment even when subjected thereto in the production of a light-emitting device, thus sufficiently preventing disadvantages such as the occurrences of deformation, coloration and abnormality in appearance.

### DESCRIPTION OF THE PREFERRED EMBODIMENTS

The present invention provides a method for producing a liquid crystalline polyester, the method comprising the steps of:
(A) reacting monomers to obtain a polycondensate corresponding thereto,
(B) granulating the polycondensate to obtain a granule, and
(C) subjecting the granule to solid-phase polymerization to obtain a liquid crystalline polyester, wherein the content of iron in the granule to be subjected to the step (C) is 5 ppm by weight or less.

The liquid crystalline polyester produced in the present invention is a polyester called a thermotropic liquid crystal polymer and forms a melt which optically exhibits anisotropy at 450° C. or lower. The liquid crystalline polyester includes, for example, polyesters represented by the followings (1) to (4).

(1): Polyester obtained by polymerizing an aromatic hydroxycarboxylic acid, an aromatic dicarboxylic acid and an aromatic diol in combination.
(2): Polyester obtained by polymerizing a plurality of kinds of aromatic hydroxycarboxylic acids.
(3): Polyester obtained by polymerizing an aromatic dicarboxylic acid and an aromatic diol in combination.
(4): Polyester obtained by reacting a crystalline polyester such as polyethylene terephthalate with an aromatic hydroxycarboxylic acid.

Regarding the production of a liquid crystalline polyester, in place of the aromatic hydroxycarboxylic acid, the aromatic dicarboxylic acid or the aromatic diol, an ester-forming derivative thereof can also be used and use of the ester-forming derivative has an advantage that it becomes easier to produce a liquid crystalline polyester.

Examples of the ester-forming derivative of the aromatic hydroxycarboxylic acid or aromatic dicarboxylic acid having a carboxyl group in the molecule include those in which the carboxyl group is converted into a highly reactive group such as a haloformyl group or an acyloxycarbonyl group, and those which form an ester with alcohols or ethylene glycol so that the carboxyl group forms a polyester by an ester exchange reaction. Examples of the ester-forming derivative of the aromatic hydroxycarboxylic acid or aromatic diol having a phenolic hydroxyl group in the molecule include those form an ester with lower carboxylic acids so that the phenolic hydroxyl group forms a polyester by an ester exchange reaction.

Furthermore, the above aromatic hydroxycarboxylic acid, the aromatic dicarboxylic acid or the aromatic diol may have, as a substituent, a halogen atom such as a chlorine atom or a fluorine atom; an alkyl group such as a methyl group or an ethyl group; or an aryl group such as a phenyl group in the aromatic ring as long as the substituent does not inhibits ester formability.

Examples of a structural unit derived from the aromatic hydroxycarboxylic acid constituting the liquid crystalline polyester include the followings.

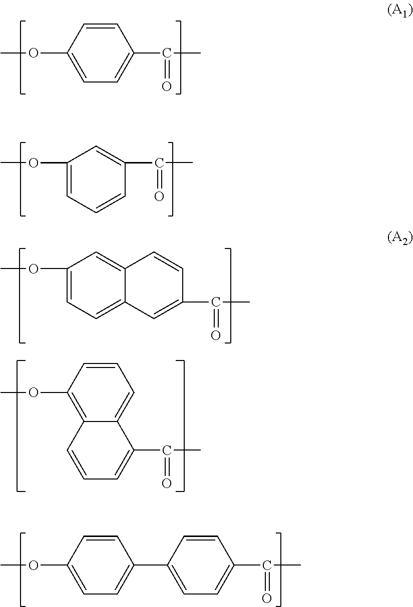

The above structural unit may have a halogen atom, an alkyl group or an aryl group as the substituent.

Examples of a structural unit derived from the aromatic dicarboxylic acid constituting the liquid crystalline polyester include the followings.

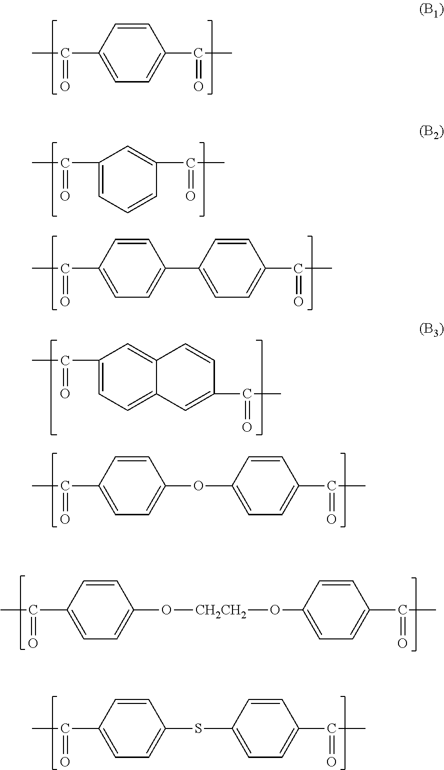

The above structural unit may have a halogen atom, an alkyl group or an aryl group as the substituent.

Examples of a structural unit derived from the aromatic diol constituting the liquid crystalline polyester include the followings.

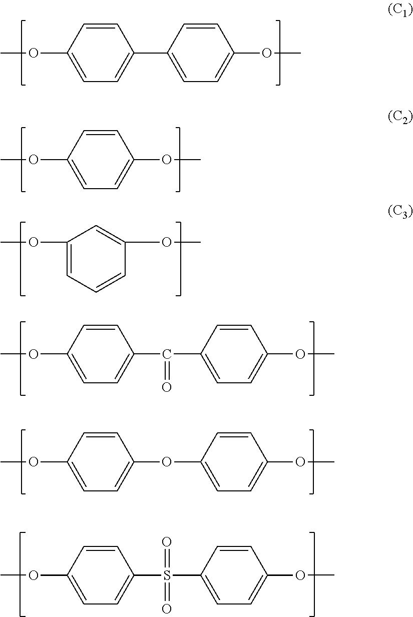

The above structural unit may have a halogen atom, an alkyl group or an aryl group as the substituent.

Examples of the suitable liquid crystalline polyester include those having a combination of structural units represented by the followings (a) to (h):

### (a): Combination of (A₁), (B₁) and (C₁), or Combination of (A₁), (B₁), (B₂) and (C₁),

### (b): Combination of (A₂), (B₃) and (C₂), or Combination of (A₂), (B₁), (B₃) and (C₂),

### (c): Combination of (A₁) and (A₂),

(d): Each of combinations of the structural unit (a) in which a portion or all of (A₁) is replaced with (A₂),
(e): Each of combinations of the structural unit (a) in which a portion or all of (B₁) is replaced with (B₃),
(f): Each of combinations of the structural unit (a) in which a portion or all of (C₁) is replaced with (C₃),
(g): Each of combinations of the structural unit (b) in which a portion or all of (A₂) is replaced with (A₁), and
(h): Combination of the structural unit (C) to which (B₁) and (C₂) are added.

As in the above (a) to (h), the liquid crystalline polyester produced in the present invention preferably has (A₁) and/or (A₂) as a structural unit derived from the aromatic hydroxycarboxylic acid, at least one kind selected from the group consisting of (B₁), (B₂) and (B₃) as a structural unit derived from the aromatic diol, and at least one kind selected from the group consisting of (C₁), (C₂) and (C₃) as a structural unit derived from the aromatic dicarboxylic acid. As described above, these structural units may have a substituent in the aromatic ring. However, when the obtained reflector plate requires more excellent heat resistance, it is desired that the structural unit has no substituent.

The liquid crystalline polyester produced by the present invention preferably has a flow temperature within a range from 280 to 400° C., and more preferably from 300 to 380° C. The liquid crystalline polyester having a flow temperature within the above range enables more easy molding to a reflector plate. When the obtained reflector plate is used, for example, in a light-emitting device including LED as a light-emitting element, it is possible to effectively prevent disadvantages that the reflector plate is deformed under a high-temperature environment during an LED module assembling step, and the reflector plate undergoes coloration, resulting in a decrease in a reflectance.

The flow temperature as used herein means the temperature at which a melt viscosity shows 4,800 Pa·second when a hot melt is extruded through a nozzle measuring 1 mm in inner diameter and 10 mm in length at a temperature rise rate of 4° C./minute under a load of 9.8 MPa using a capillary narrow rheometer equipped with the nozzle. This flow temperature is an indicator of a molecular weight of a liquid crystalline polyester known in the art (see “Synthesis, Molding and Application of Liquid Crystal Polymers”, edited by Naoyuki Koide, pp. 95-105, CMC, published on Jun. 5, 1987).

In the present invention, the liquid crystalline polyester is produced by a method for producing a liquid crystalline polyester, the method including the steps of:
(A) reacting monomers to obtain a polycondensate corresponding thereto,
(B) granulating the polycondensate to obtain a granule, and
(C) subjecting the granule to solid-phase polymerization to obtain a liquid crystalline polyester.

In the step (A), polymerization may be conducted by a direct polymerization method or an ester exchange method. Examples of the polymerization method include a suspension polymerization method, an interfacial polymerization method, a solution polymerization method and a melt polymerization method. Of these methods, a melt polymerization method is preferably used since it is easy to remove a solvent and to wash a polymer. A polycondensation process can be a batch-wise process, a continuous process, or a combination thereof.

A reaction tank may have a vertical or horizontal shape. In the vertical reaction tank, a blade such as a multi-stage puddle blade, a turbine blade, a monte blade or a double helical blade is preferably disposed. In the horizontal reaction tank, a blade such as a lens blade, an eyeglass blade or a multi-disc plate blade is preferably disposed vertically to a mono-screw or twin-screw stirring shaft. A blade having a stirring performance and a feeding mechanism improved by being provided with torsion is also preferred. The reaction tank is heated, for example, by a heat medium, a gas or an electric heater. However, a stirring shaft, a blade, a baffle plate and the like are preferably heated for the purpose of uniform heating.

A material of the reaction tank is preferably corrosion-resistant since acetic acid is produced as a reaction by-product, and examples of the material include glass lining, SUS316, SUS316L, two-phase stainless steel, nickel-molybdenum alloy such as Hastelloy-B or Hastelloy-C, impermeable graphite, titanium, zirconium and tantalum.

In the present invention, the liquid crystalline polyester may be produced using monomers each having a phenolic hydroxyl group as a portion of the monomers to be reacted, and acylating the monomers having the phenolic hydroxyl group with a fatty acid anhydride before starting the step (A) to obtain the acylates corresponding thereto, followed by the steps (A), (B) and (C).

One of typical examples of such a production method may be conducted as follows:

A monomer mixture of an aromatic hydroxycarboxylic acid, an aromatic diol and an aromatic dicarboxylic acid is mixed with a fatty acid anhydride and the mixture is reacted in a nitrogen atmosphere at 130 to 180° C. thereby acylating phenolic hydroxyl groups of the aromatic hydroxycarboxylic acid and the aromatic diol with the fatty acid anhydride to obtain an acrylate (aromatic hydroxycarboxylic acid acrylate and aromatic diol acylate). After further heating, polycondensation by ester exchange is conducted while distilling the reaction by-product out of the reaction system so as to generate an exchange of an acyl group of the acrylate with the residue remaining after removing hydroxyl groups from carboxyl groups existing in the aromatic hydroxycarboxylic acid acrylate and the aromatic dicarboxylic acid, and thus a liquid crystalline polyester is produced. In the mixture of the aromatic hydroxycarboxylic acid, the aromatic diol and the aromatic dicarboxylic acid, a molar ratio of the carboxyl group to the phenolic hydroxyl group is preferably from 0.9 to 1.1.

The ester exchange reaction (one type of polycondensations) is preferably conducted while heating at a rate of 0.1 to 50° C./minute within a range from 130 to 400° C., and more preferably at a rate of 0.3 to 5° C./minute within a range from 150 to 350° C. The reaction by-product is distilled out of the system so as to conduct the ester exchange (polycondensation) reaction more smoothly.

A molar ratio of the fatty acid anhydride to the total phenolic hydroxyl groups of the aromatic diol and the aromatic hydroxycarboxylic acid is preferably from 0.95 to 1.2, and more preferably from 1.00 to 1.15. As the amount of the fatty acid anhydride used becomes smaller, coloration of the obtained liquid crystalline polyester tends to be suppressed. However, when the amount of the fatty acid anhydride used is too small, the unreacted aromatic diol or aromatic dicarboxylic acid is likely to undergo sublimation upon polycondensation and thus clogging of the reaction system may occur. In contrast, when the amount of the fatty acid anhydride used is too large, the obtained liquid crystalline polyester is likely to undergo coloration and thus a reflectance of the obtained reflector plate may decrease. In light of these points, the amount of the fatty acid anhydride used is preferably within the above range.

Examples of the fatty acid anhydride include acetic anhydride, propionic anhydride, butyric anhydride, isobutyric anhydride, valeric anhydride, pivalic anhydride, 2-methylhexanoic anhydride, monochloroacetic anhydride, dichloroacetic anhydride, trichloroacetic anhydride, monobromoacetic anhydride, dibromoacetic anhydride, tribromoacetic anhydride, monofluoroacetic anhydride, difluoroacetic anhydride, trifluoroacetic anhydride, glutaric anhydride, maleic anhydride, succinic anhydride and β-bromopropionic anhydride, and two or more kinds of these fatty acid anhydrides may be optionally used in combination. From the viewpoints of economical efficiency and handling properties, acetic anhydride, propionic anhydride, butyric anhydride and isobutyric anhydride are preferably used, and acetic anhydride is particularly preferably used.

From the viewpoint of more smooth production of a liquid crystalline polyester and sufficient suppression of coloration of the obtained liquid crystalline polyester, the ester exchange reaction (one type of polycondensations) is preferably conducted in the presence of a heterocyclic organic base compound containing two or more nitrogen atoms. Examples of the heterocyclic organic base compound include an imidazole compound, a triazole compound, a dipyridyl compound, a phenanthroline compound and a diazaphenanthrene compound. Of these compounds, an imidazole compound is preferably used from the viewpoint of the reactivity according to the polycondensation, and 1-methylimidazole and 1-ethylimidazole are more preferably used from the viewpoint of easy availability.

For the purpose of increasing a polycondensation rate by further accelerating the ester exchange reaction, it is also possible to use catalysts other than the above heterocyclic organic base compound as long as the object of the present invention is not impaired. Provided that a metal salt or the like is used as the catalyst, the metal salt remains as impurities in the liquid crystalline polyester and therefore may exert an adverse influence on electronic components such as a reflector plate. Also in this respect, use of the heterocyclic organic base compound is preferred so as to produce a liquid crystalline polyester.

When the polycondensation is conducted by a melt polymerization method and a polycondensate (liquid crystalline polyester) is extracted from a polymerization tank in a molten state, the polycondensation is preferably conducted using the polymerization tank in an atmosphere of an inert gas such as nitrogen under normal pressure, or in an atmosphere of an inert gas such as nitrogen under a pressure of preferably from 0.1 to 2 kg/cm²G, and more preferably from 0.2 to 1 kg/cm²G so as to suppress an increase in a flow temperature of the polycondensate upon extraction. Examples of a mechanism of extracting the polycondensate in a molten state include an extruder, a pump such as a gear pump, a piston pump or a centrifugal pump; a valve such as a ball valve or a diaphragm valve; and a narrow passage type feeder such as a nozzle type narrow passage type feeder.

In the subsequent step (B), the polycondensate obtained in the step (A) is granulated. As a method of granulating the polycondensate, for example, the polycondensation is conducted by a melt polymerization method. When the polycondensate is extracted from the polymerization tank in a molten state, since the extracted polycondensate is usually solidified in a few minutes, a method of producing a particulate matter by pulverizing using a pulverizing machine (which may be a commonly used pulverizing machine) after solidifying under cooling is exemplified. There is also exemplified a method in which the polycondensate is formed into pellets by cutting using a strand cutter or a sheet cutter while solidifying into a string from a molten state under cooling. As a means for treating a large amount within a short time, for example, a method of cooling using a cooler such as a steel belt or a drum cooler.

Pulverization is preferably conducted by mechanical pulverization. Examples of a pulverizing machine used in this case include a feather mill, a victory mill, a colloplex, a pulverizer, a contraplex and scroll mill manufactured by Hosokawa Micron Corporation; an impact type pulverizing machine such as an ACM pulverizer; and a roll granulator such as a bridging-and-cracking type pulverizing machine manufactured by MATSUBO Corporation. In particular, a feather mill manufactured by Hosokawa Micron Corporation is preferred.

A particle diameter of a granule (particulate matter or pellet) is preferably 10 mm or less, more preferably 5 mm or less, and still more preferably from 0.1 to 0.4 mm. In a case where the particle diameter of a granule is too large, when the granule is polycondensated in a solid phase in the subsequent step (C), there is a difference in the polymerization rate and the diffusion time of by-product produced as a result of the unreacted raw materials between a surface layer and the inside. Therefore, it is impossible to widen molecular weight distribution and to sufficiently remove those to be removed, thus unfavorably causing foaming and the generation of a gas. Pulverization may be conducted in a single stage to obtain particles having the desired particle diameter. Alternatively, pulverization may be conducted in a plurality of stages, for example, coarse pulverization and fine pulverization.

A shape of the granule is not particularly limited and examples thereof include generally sphere, cylinder, rectangular parallelepiped, cone, oval, square pyramid and triangular pyramid.

In the present invention, the granule subjected to the subsequent step (C) has a content of iron of 5 ppm by weight or less, which works in providing a liquid crystalline polyester having high whiteness. In order to adjust the content of iron in the granule subjected to the subsequent step (C) to 5 ppm by weight or less, it is preferred that a portion which comes into contact with the polycondensate, of the pulverizing machine is composed of an acid-resistant material. Under such preferable conditions, elution of iron in the pulverization step can be efficiently suppressed. Examples of the acid-resistant material include SUS304, SUS304L, SUS316 and SUS316L. It is also effective to select those having low iron content from commercially available monomers. Furthermore, it is also a preferable to conduct a washing step of the granule with an acidic aqueous solution before starting the step (C) for adjusting the iron content of the granule to 5 ppm by weight or less. Examples of the acidic aqueous solution include inorganic acids such as hydrochloric acid, sulfuric acid and nitric acid; and organic acids such as oxalic acid, citric acid and formic acid. Washing is preferably conducted by charging the granule into at least 3-fold amount by weight of the acidic aqueous solution, followed by stirring. In this case, a stirring rotation speed is preferably 150 rpm or more. Upon stirring, ultrasonic waves may be applied. The acidic aqueous solution is preferably an inorganic acid, more preferably hydrochloric acid, from the viewpoint of costs and effective removal of iron.

In the subsequent step (C), the granule obtained in the step (B) is subjected to solid-phase polymerization. Herein, the granules to be subjected to the solid-phase polymerization has an iron content of 5 ppm by weight or less, as described above. The solid-phase polymerization can be conducted under normal pressure or reduced pressure, but is preferably conducted under normal pressure since a solid-phase polymerization apparatus becomes simple. Preferably, a temperature raising rate and the maximum temperature upon the solid-phase polymerization are selected so as to prevent the fusion of granulates as much as possible. When the fusion occurs, a surface area decreases, and a polycondensation reaction and removal of a low boiling point component are not quickly conducted, unfavorably. The maximum temperature of the solid-phase polymerization is preferably from 230 to 350° C., and more preferably from 260 to 330° C., and it is effective to treat under an inert gas atmosphere. When the maximum temperature is too low, the solid-phase polymerization slowly proceeds and requires a long time, resulting in lack of economy. In contrast, when the maximum temperature is too high, the granules are likely to be fused or melted each other and thus it becomes difficult to maintain a solid phase, unfavorably.

Preferably, the temperature raising rate of the solid-phase polymerization is selected so that the temperature is homogeneously raised between a surface layer and the inside of the granule. The maximum temperature of the solid-phase polymerization is preferably the temperature which is a flow temperature or lower so as not to fuse the granule, and a solid-phase polymerization time is preferably from 1 minute to 24 hours, and more preferably 5 minutes to 12 hours.

As a solid-phase polymerization apparatus, various dryers, reactors, mixers and electric furnaces can be used. Examples thereof include a tray type oven, a rotary kiln and a fluidized bed type dryer. Of these solid-phase polymerization apparatuses, a gas circulation type apparatus having high sealing degree is preferred for the above purposes. The inert gas is preferably those selected from nitrogen, helium, argon and carbon dioxide gas, and more preferably nitrogen. When air, particularly oxygen, exists, the liquid crystalline polyester is oxidized at a high temperature, and deterioration of physical properties and coloration are likely to occur, unfavorably. A flow rate of an inert gas is determined taking a volume of a solid-phase polymerization apparatus, and a particle diameter and filling state of the granule into consideration, and the flow rate is preferably from 2 m³/hr to 8 m³/hr, and more preferably from 3 m³/hr to 6 m³/hr, per 1 m³ of the solid-phase polymerization tank. When the flow rate of an inert gas is too small, the polymerization rate is slow. In contrast, when the flow rate of an inert gas is too large, scattering of the granule may occur.

The liquid crystalline polyester thus obtained is particularly preferred as a material of a reflector plate when a YI value is 32 or less. The YI value is an indicator which represents a yellowness index of an object and is a value defined by the following equation. The YI value can be obtained by using a colorimeter in accordance with ASTM D1925, with respect to a specimen made of a liquid crystalline polyester:

YI=[100(1.28×−1.06Z)/Y]

wherein X, Y and Z are tristimulus values of a light source color in an XYZ color coordinate system.

The liquid crystalline polyester having a YI value of 32 or less can also be obtained as a liquid crystalline polyester mixture having a YI value of 32 or less by mixing a plurality of kinds of liquid crystalline polyesters.

The liquid crystalline polyester thus obtained can be used alone or in combination with other components for various applications. Particularly, the liquid crystalline polyester composition of the present invention obtained by blending the above liquid crystalline polyester with a titanium oxide filler can be suitably used as a material of a reflector plate, utilizing high whiteness thereof. That is, the present invention provides a liquid crystalline polyester composition comprising a titanium oxide filler and a liquid crystalline polyester produced by the above-described method.

The titanium oxide filler may be a filler containing titanium oxide, and a crystal form of titanium oxide per se to be contained is not particularly limited and can be a rutile type or anatase type crystal form, or a mixture thereof. From the viewpoint of the fact that a reflector plate having a high reflectance is obtained and also weatherability of the reflector plate becomes satisfactory, a titanium oxide filler containing a rutile type titanium oxide is preferably used, and a titanium oxide filler substantially containing only a rutile type titanium oxide as the titanium oxide is more preferably used.

Also, there is not a particularly limitation on an average particle diameter of the titanium oxide filler. From the viewpoint of a reflectance of the obtained reflector plate and filler dispersibility in the reflector plate, the average particle diameter is preferably from 0.10 to 0.50 μm, more preferably from 0.15 to 0.40 μm, and still more preferably from 0.18 to 0.35 μm. It is possible to use a titanium oxide filler having an optimum average particle diameter, taking a thickness of a reflector plate to be produced into consideration.

The average particle diameter as used herein is a particle diameter (volume average particle diameter) at a cumulative frequency of 50% in a distribution curve formed by observing a titanium oxide filler using a scanning electron microscopy (SEM), analyzing the obtained SEM micrograph using an image analysis equipment (for example, LUZEX IIIU manufactured by Nireco Corporation), determining an amount of particles (%) in each particle diameter section of primary particles and accumulating each of the amounts on a volume basis.

The content of the titanium oxide filler in the liquid crystalline polyester composition of the present invention is preferably from 20 to 120 parts by weight, more preferably from 30 to 100 parts by weight, and still preferably from 40 to 80 parts by weight, based on 100 parts by weight of the liquid crystalline polyester. When the content of the titanium oxide filler is too small, the obtained reflector plate may not have a sufficient reflectance. In contrast, when the content of the titanium oxide filler is too large, it tends to become difficult to produce the reflector plate per se and characteristics such as mechanical properties and heat resistance of the liquid crystalline polyester may not be sufficiently maintained. When a plurality of kinds of titanium oxide fillers are used as the titanium oxide filler, the total amount may be within the above range based on the liquid crystalline polyester.

The titanium oxide filler may be obtained by subjecting titanium oxide to a surface treatment for the purpose of improving characteristics such as dispersibility. There is no particular limitation on the surface treatment. From the viewpoint of improvement in dispersibility and weatherability, a surface treatment of an inorganic metal oxide is preferred and the inorganic metal oxide is preferably aluminum oxide (alumina). Provided that it is easy to handle because of free from aggregation, titanium oxide which is not subjected to a surface treatment is preferred from the viewpoint of heat resistance and strength.

The titanium oxide filler is preferably a titanium oxide filler containing titanium oxide produced by a chlorination method. Herein, the chlorination method is a method in which an ore (synthetic rutile obtained from rutile ore, ilmenite ore, etc.) as a titanium source is reacted with chlorine at around 1,000° C. to give a crude titanium tetrachloride and, after purifying the crude titanium tetrachloride by rectification, the obtained titanium tetrachloride is oxidized with oxygen to obtain titanium oxide. According to this chlorination method, it becomes easy to obtain rutile type titanium oxide having a suitable crystal form. By optimizing the conditions in the step of oxidizing with oxygen (oxidation step), it is easy to obtain titanium oxide having comparatively excellent whiteness and a titanium oxide filler containing such titanium oxide is particularly suited for use as a titanium oxide filler in the liquid crystalline polyester composition of the present invention. By optimizing the conditions in the oxidation step, the production of coarse particles are suppressed, and thus it becomes easy to obtain a titanium oxide filler having an average particle diameter which is suited for use as a titanium oxide filler in the liquid crystalline polyester composition of the present invention.

Examples of a commercially available product of the titanium oxide filler include “TIPAQUE CR-60” and “TIPAQUE CR-58” of ISHIHARA SANGYO KAISHA, LTD.; and “SR-1” of SAKAI CHEMICAL INDUSTRY CO., LTD.

The liquid crystalline polyester composition of the present invention may contain inorganic fillers other than the titanium oxide filler for the purpose of improving mechanical properties of the reflector plate as long as the reflectance of the obtained reflector plate is not drastically impaired.

In this case, a content of the inorganic filler is preferably from 5 to 100 parts by weight or less, and more preferably from 5 to 90 parts by weight, based on 100 parts by weight of the liquid crystalline polyester. When the content of the inorganic filler is too large, a color tone of the reflector plate may deteriorate. In the case of molding into a small-sized reflector plate, moldability is likely to deteriorate.

The inorganic filler may be a fibrous filler, a plate-like filler, or a granular filler. Examples of the fibrous filler include a glass fiber, a PAN-based or pitch-based carbon fiber, a silicon carbide fiber, an asbestos fiber, a gypsum fiber, a ceramic fiber, a metal fiber such as a stainless steel fiber, an aluminum fiber or a brass fiber, a zirconia fiber, an alumina fiber, a silica fiber, an alumina silicate fiber, a titanium oxide fiber, a silicon carbide fiber, a boron fiber, a potassium titanate whisker, a barium titanate whisker, a calcium carbonate whisker, a wollastonite whisker, an aluminum borate whisker, a zinc oxide whisker, a silicon nitride whisker, a silicon carbide whisker and asbestos. Examples of the plate-like filler include smectites such as montmorillonite, beidellite, nontronite, saponite, hectorite, sauconite, stevensite, Na hectorite, Li hectorite and saponite; layered polysilicates such as kanemite and kenyaite; micas such as phlogopite, muscovite, sericite, fluorine phlogopite, K tetrasilicic mica, Na tetrasilicic mica, Na taeniolite and Li taeniolite; white lead, talc, wollastonite, bentonite, kaolin, halloysite, kaolinite, vermiculite, chlorite, pyrophyllite, clay, zirconium phosphate, titanium phosphate, graphite, alumina, zeolite, magnesium hydroxide, aluminum hydroxide, zirconium oxide, boron nitride, iron oxide, calcium carbonate, calcium sulfate, barium sulfate and glass flake. Examples of the granular filler include silica, ceramic beads, glass beads, hollow glass beads, carbon black, alumina, zeolite, magnesium hydroxide, aluminum hydroxide, magnesium oxide, zirconium oxide, boron nitride, silicon carbide, iron oxide, calcium carbonate, magnesium carbonate and calcium sulfate. Of these inorganic fillers, the fibrous filler such as a glass fiber, a titanium oxide fiber and a wollastonite whisker; and the plate-like filler such as talc and mica are preferred so as to impart practical mechanical strength to the reflector plate without drastically decreasing the reflectance of the reflector plate. In these inorganic fillers, silane-based and titanate-based coupling agents, and other surface treatment agents are sometimes used. However, from the viewpoint of suppression of deterioration of a color tone, the smaller the amount of the surface treatment agent used, it becomes better.

The liquid crystalline polyester composition of the present invention may contain additives, for example, mold release improvers such as a fluorine resin, a higher fatty acid ester compound and fatty acid metal soaps; colorants such as dyes and pigments; antioxidants; heat stabilizers; fluorescent whitening agents; ultraviolet absorbers; antistatic agents; and surfactants as long as the object of the present invention is not impaired. The liquid crystalline polyester composition may also contain additives having an external lubricant effect, such as a higher fatty acid, a higher fatty acid ester, a higher fatty acid metal salt and a fluorocarbon-based surfactant.

The liquid crystalline polyester composition of the present invention can be obtained by mixing a liquid crystalline polyester, a titanium oxide filler, and other components such as an inorganic filler optionally used, using a Henschel mixer or a tumbler. Alternatively, after mixing as described above, a resin composition may be pelletized by melt-kneading the mixture using an extruder. The resin composition thus obtained by pelletizing has satisfactory operability and can broad a selection width of a suitable molding method by the shape of the objective components.

In the present invention, a reflector plate can be produced by molding the liquid crystalline polyester composition described above. That is, the reflector plate of the present invention can be obtained by molding the liquid crystalline polyester composition of the present invention using various molding methods commonly used. The molding method is suitably a melt molding method such as an injection molding method, an injection compression molding method or an extrusion molding method. In particular, an injection molding method is preferred and, according to the injection molding method, it is possible to produce a reflector plate having a thin wall portion or a reflector plate having a complicated shape. In particular, the injection molding method is suited for the production of a small-sized reflector plate including a thin wall portion of 0.01 mm to 3.0 mm, preferably 0.02 to 2.0 mm, and more preferably 0.05 to 1.0 mm. The injection molding method is particularly advantageous for the production of a reflector plate which requires heat resistance.

A molding temperature according to melt molding such as injection molding is preferably a temperature which is 10 to 60° C. higher than a flow temperature of the liquid crystalline polyester composition used for melt molding. When the molding temperature is too low, fluidity of the liquid crystalline polyester composition may drastically decrease, resulting in deterioration of moldability and a decrease in strength of a reflector plate. In contrast, when the molding temperature is too high, the liquid crystalline polyester may be likely to deteriorate, resulting in a decrease in a reflectance of a reflector plate. The flow temperature of the liquid crystalline polyester composition can be determined in the same manner as in the method described as a method of measuring the flow temperature of the liquid crystalline polyester, using a capillary narrow rheometer.

The reflector plate of the present invention is extremely excellent in a reflectance to light in a visible light range, particularly a reflectance to blue light. Specifically, it becomes possible to produce a reflector plate having a reflectance of 75% or more to rays with a wavelength of 460 nm. It is also possible to produce a reflector plate having a reflectance of 80% or more. The reflectance as used herein is determined based on the method A for measurement of total light reflectance (standard white plate: barium sulfate) in accordance with JIS K7105-1981.

The reflector plate of the present invention can be suitably used as a member involved in light reflection, particularly visible light reflection, in the fields of electricity, electronics, automobile and mechanics. For example, the reflector plate can be suitably used as a lamp reflector of light source devices such as halogen lamp and HID; and a high-strength reflector plate of light-emitting devices and display apparatuses using light-emitting elements such as LED and organic EL. In particular, the reflector plate can be suitably used as a reflector plate of light-emitting devices using LED.

### EXAMPLES

Examples of the present invention will be described hereinbelow, but the present invention is not limited thereto. In Examples, methods for measuring iron content and an L* value (lightness) as are follows.

### Iron Content

After weighing about 1 g of a sample, an ashing treatment was conducted at about 700° C. After dissolving in about 5% nitric acid under heating, a volume was determined as a 25 ml of a measuring solution and the measurement was conducted by ICP-AES to determine the content of iron (ppm by weight) in the sample.

### L* Value (Lightness)

Using a colorimeter (“CR-300”, manufactured by Konica Minolta Holdings, Inc.), the measurement was conducted.

### Production Example 1

Into a reactor equipped with a stirrer, a torque meter, a nitrogen gas introducing tube, a thermometer and a reflux condenser, 100 parts by weight of parahydroxybenzoic acid, 44.9 parts by weight of 4,4′-dihydroxybiphenyl, 30.1 parts by weight of terephthalic acid, 10.0 parts by weight of isophthalic acid and 135.5 parts by weight acetic anhydride were charged and 0.02 parts by weight of 1-methylimidazole was added. After the atmosphere in the reactor was sufficiently replaced with a nitrogen gas, a temperature was raised to 150° C. over 30 minutes under a nitrogen gas flow and the mixture was refluxed for 1 hour while maintaining the temperature. Then, 0.09 parts by weight of 1-methylimidazole was added and the temperature was raised to 320° C. over 2 hours and 50 minutes while distilling off the by-product acetic acid thus distilled out and the unreacted acetic anhydride. The point in time at which an increase in torque is recognized was considered as completion of the reaction, and a polycondensate (liquid crystalline polyester) was obtained (step (A)).

### Example 1

The polycondensate obtained in Production Example 1 was cooled to room temperature, pulverized by a coarse pulverizing machine in which a material of a portion to be contacted with the polycondensate is SUS304 and then finely pulverized by a fine pulverizing machine to obtain granulate having an iron content of 3.9 ppm by weight (step (B)).

The obtained granulate was subjected to a solid-phase polymerization by raising a temperature from room temperature to 250° C. over 1 hour under a nitrogen atmosphere, raising a temperature from 250° C. to 285° C. over 5 hours and then maintaining at 285° C. for 3 hours (step (C)). After the solid-phase polymerization, the granule (liquid crystalline polyester) showed a flow temperature of 327° C. L* values of the granule before and after the solid-phase polymerization were measured. The results are shown in Table 1.

### Example 2

The polycondensate obtained in Production Example 1 was cooled to room temperature, pulverized by a coarse pulverizing machine in which a material of a portion to be contacted with the polycondensate is SUS304 and then finely pulverized by a fine pulverizing machine to obtain granulate having an iron content of 2.6 ppm by weight (step (B)).

The obtained granulate was subjected to a solid-phase polymerization by raising a temperature from room temperature to 250° C. over 1 hour under a nitrogen atmosphere, raising a temperature from 250° C. to 285° C. over 5 hours and then maintaining at 285° C. for 3 hours (step (C)). After the solid-phase polymerization, the granule (liquid crystalline polyester) showed a flow temperature of 327° C. L* values of the granule before and after the solid-phase polymerization were measured. The results are shown in Table 1.

### Comparative Example 1

The polycondensate obtained in Production Example 1 was cooled to room temperature, pulverized by a coarse pulverizing machine in which a material of a portion to be contacted with the polycondensate is a Kanigen-plated steel material and then finely pulverized by a fine pulverizing machine to obtain granulate having an iron content of 16.6 ppm by weight (step (B)).

The obtained granulate was subjected to a solid-phase polymerization by raising a temperature from room temperature to 250° C. over 1 hour under a nitrogen atmosphere, raising a temperature from 250° C. to 285° C. over 5 hours and then maintaining at 285° C. for 3 hours (step (C)). After the solid-phase polymerization, the granule (liquid crystalline polyester) showed a flow temperature of 327° C. L* values of the granule before and after the solid-phase polymerization were measured. The results are shown in Table 1.

### Comparative Example 2

The polycondensate obtained in Production Example 1 was cooled to room temperature, pulverized by a coarse pulverizing machine in which a material of a portion to be contacted with the polycondensate is a Kanigen-plated steel material and then finely pulverized by a fine pulverizing machine to obtain granulate having an iron content of 10.5 ppm by weight (step (B)).

The obtained granulate was subjected to a solid-phase polymerization by raising a temperature from room temperature to 250° C. over 1 hour under a nitrogen atmosphere, raising a temperature from 250° C. to 285° C. over 5 hours and then maintaining at 285° C. for 3 hours (step (C)). After the solid-phase polymerization, the granule (liquid crystalline polyester) showed a flow temperature of 327° C. L* values of the granule before and after the solid-phase polymerization were measured. The results are shown in Table 1.

### Production Example 2

Into a reactor equipped with a stirrer, a torque meter, a nitrogen gas introducing tube, a thermometer and a reflux condenser, 100 parts by weight of parahydroxybenzoic acid, 44.9 parts by weight of 4,4′-dihydroxybiphenyl, 36.1 parts by weight of terephthalic acid, 4.0 parts by weight of isophthalic acid and 135.5 parts by weight of acetic anhydride were charged and 0.02 parts by weight of 1-methylimidazole was added. After the atmosphere in the reactor was sufficiently replaced with a nitrogen gas, a temperature was raised to 150° C. over 30 minutes under a nitrogen gas flow and the mixture was refluxed for 1 hour while maintaining the temperature. Then, the temperature was raised to 320° C. over 2 hours and 50 minutes while distilling off the by-product acetic acid thus distilled out and the unreacted acetic anhydride. The point in time at which an increase in torque is recognized was considered as completion of the reaction, and a polycondensate (liquid crystalline polyester) was obtained (step (A)).

### Example 3

The polycondensate obtained in Production Example 2 was cooled to room temperature, pulverized by a coarse pulverizing machine in which a material of a portion to be contacted with the polycondensate is a Kanigen-plated steel material and then finely pulverized by a fine pulverizing machine to obtain granulate having an iron content of 7.0 ppm by weight (step (B)).

The obtained granulate was charged into a 20-fold (by weight) amount of 1N hydrochloric acid, followed by stirring at room temperature for 30 minutes and further washing with pure water. After washing, the granule had an iron content of 2.0 ppm by weight.

The granule obtained after washing was subjected to a solid-phase polymerization by raising a temperature from room temperature to 250° C. over 1 hour under a nitrogen atmosphere, raising a temperature from 250° C. to 305° C. over 5 hours and then maintaining at 305° C. for 3 hours (step (C)). After the solid-phase polymerization, the granule (liquid crystalline polyester) showed a flow temperature of 357° C. L* values of the granule before and after the solid-phase polymerization were measured. The results are shown in Table 1.

### Comparative Example 3

The granule having an iron content of 7.0 ppm by weight obtained in Example 3 was subjected to a solid-phase polymerization without washing with 1N hydrochloric acid by raising a temperature from room temperature to 250° C. over 1 hour under a nitrogen atmosphere, raising a temperature from 250° C. to 305° C. over 5 hours and then maintaining at 305° C. for 3 hours (step (C)). After the solid-phase polymerization, the granule (liquid crystalline polyester) showed a flow temperature of 357° C. L* values of the granule before and after the solid-phase polymerization were measured. The results are shown in Table 1.

TABLE 1

| | | | Comparative | Comparative | | Comparative |
|---|---|---|---|---|---|---|
| | Example 1 | Example 2 | Example 1 | Example 2 | Example 3 | Example 3 |
| Polycondensation | Production | Production | Production | Production | Production | Production |
| | Example 1 | Example 1 | Example 1 | Example 1 | Example 2 | Example 2 |
| Iron content | 3.9 | 2.6 | 16.6 | 10.5 | 2.0 | 7.0 |
| (ppm) | | | | | | |
| L* value before | 86.8 | 87.4 | 86.4 | 87.7 | 84.1 | 84.1 |
| solid-phase | | | | | | |
| polymerization | | | | | | |
| L* value after | 83.7 | 84.1 | 80.5 | 83.0 | 82.0 | 79.6 |
| solid-phase | | | | | | |
| polymerization | | | | | | |
| Δ L* value | 3.1 | 3.3 | 5.9 | 4.7 | 2.1 | 4.5 |

What is claimed is:

1. A method for producing a liquid crystalline polyester, the method comprising the steps of:
(A) reacting monomers to obtain a polycondensate corresponding thereto,
(B) granulating the polycondensate to obtain a granule, and
(C) subjecting the granule to solid-phase polymerization to obtain a liquid crystalline polyester, wherein the content of iron in the granule to be subjected to the step (C) is 5 ppm by weight or less.

2. The method for producing a liquid crystalline polyester according to claim 1, wherein the monomers are an aromatic hydroxycarboxylic acid, an aromatic dicarboxylic acid and an aromatic diol.

3. The method for producing a liquid crystalline polyester according to claim 1,
wherein a portion of the monomers each have a phenolic hydroxyl group and
wherein the method further comprises the step of acylating the monomers having the phenolic hydroxyl group with a fatty acid anhydride before starting the step (A) to obtain the acylates corresponding thereto, followed by the reaction of the monomers and/or the acylates in the step (A).

4. The method for producing a liquid crystalline polyester according to claim 1, wherein the polycondensate is granulated by mechanical pulverization using a pulverizing machine in the step (B).

5. The method for producing a liquid crystalline polyester according to claim 4, wherein a portion which comes into contact with the polycondensate, of the pulverizing machine is composed of an acid-resistant material.

6. The method for producing a liquid crystalline polyester according to claim 1, the method further comprising the step of washing the granule with an acidic aqueous solution before starting the step (C).

7. A liquid crystalline polyester composition comprising a titanium oxide filler and a liquid crystalline polyester produced by the method according to claim 1.

8. A reflector plate produced by molding the liquid crystalline polyester composition according to claim 7.

9. A light-emitting device comprising a light emitting element and the reflector plate according to claim 8.
